(19) United States
(12) Patent Application Publication
(10) Pub. No.: US 2015/0052456 A1
(43) Pub. Date: Feb. 19, 2015

(54) SYSTEMS AND METHODS FOR RESHARING POSTS ACROSS SOCIAL FEED PLATFORMS

(71) Applicant: salesforce.com, inc., San Francisco, CA (US)

(72) Inventor: Eric William Engelking, West Hills, CA (US)

(21) Appl. No.: 14/458,700

(22) Filed: Aug. 13, 2014

Related U.S. Application Data
(60) Provisional application No. 61/866,624, filed on Aug. 16, 2013.

(51) Int. Cl. H04L 12/58; G06F 3/0481

(52) U.S. Cl. CPC H04L 51/046; G06F 3/0481
USPC 715/753

(57) ABSTRACT

Methods and systems are provided for resharing a feed post in an on-line multi-tenant social network. The method includes: appending, by a first member of an organization, a reshare hashtag to a post configured for publication on a first social network; publishing, by the first member, the post including the appended reshare hashtag to at least a second member of the organization on the first social network; clicking, by a second member, reshare button; selecting, by the second member, a second social network; and republishing the post on the second social network.

### CROSS-REFERENCE TO RELATED APPLICATIONS

This application claims the benefit of U.S. provisional patent application Ser. No. 61/866,624 filed Aug. 16, 2013, the entire contents of which is incorporated herein by this reference.

### TECHNICAL FIELD

Embodiments of the subject matter described herein relate generally to computer systems and applications for publishing posts across social feed platforms, and more particularly to a technique for permitting a post creator to include an enabling reshare hashtag in a feed post.

### BACKGROUND

The unprecedented growth of social technologies has redefined the way people connect and communicate. On-line social networking sites such as Facebook™, Pinterest™, Tumblr™, Google+™, Hootsuite™, Yammer™ Path™, Instagram™, Weibo™, QZone™, Vine™, and Twitter™ have forever changed the way people share information with each other. Presently known enterprise social network platforms such as Chatter™, released in June 2010 by Salesforce™ and available at www.salesforce.com, provide users with a feed-based stream of posts. Chatter users can post messages to other user's and to predefined groups within their organization. While presently known feed-based social networking platforms typically allow users to reshare (repost) posts with other authorized users within their organization, they are are not configured to allow users to reshare posts publically or otherwise outside of the organization.

At the same time, software development is evolving away from the client-server model toward network-based processing systems that provide access to data and services via the Internet or other networks. In contrast to traditional systems that host networked applications on dedicated server hardware, a “cloud” computing model allows applications to be provided over the network “as a service” supplied by an infrastructure provider. The infrastructure provider typically abstracts the underlying hardware and other resources used to deliver a customer-developed application so that the customer no longer needs to operate and support dedicated server hardware. The cloud computing model can often provide substantial cost savings to the customer over the life of the application because the customer no longer needs to provide dedicated network infrastructure, electrical and temperature controls, physical security and other logistics in support of dedicated server hardware.

Multi-tenant cloud-based architectures have been developed to improve collaboration, integration, and community-based cooperation between customer tenants without sacrificing data security. Generally speaking, multi-tenancy refers to a system where a single hardware and software platform simultaneously supports multiple user groups (also referred to as “organizations” or “tenants”) from a common data storage element (also referred to as a “multi-tenant database”). The multi-tenant design provides a number of advantages over conventional server virtualization systems. First, the multi-tenant platform operator can often make improvements to the platform based upon collective information from the entire tenant community. Additionally, because all users in the multi-tenant environment execute applications within a common processing space, it is relatively easy to grant or deny access to specific sets of data for any user within the multi-tenant platform, thereby improving collaboration and integration between applications and the data managed by the various applications. The multi-tenant architecture therefore allows convenient and cost effective sharing of similar application features between multiple sets of users.

Presently known feed-based social networking platforms do not effectively allow users to reshare posts outside the organization. Systems and methods are thus needed which facilitate this functionality.

### BRIEF DESCRIPTION OF THE DRAWING FIGURES

A more complete understanding of the subject matter may be derived by referring to the detailed description and claims when considered in conjunction with the following figures, wherein like reference numbers refer to similar elements throughout the figures.

FIG. 1 is a schematic block diagram of a multi-tenant computing environment in accordance with an embodiment;

FIG. 2 is an exemplary layout of a feed-based user interface platform within a browser window in accordance with an embodiment;

FIG. 3 is a screen shot of an exemplary Chatter feed overlaying a Twitter page, the Chatter feed including a post enabled for resharing in accordance with an embodiment;

FIG. 4 shows the screen shot of FIG. 3 depicting the user swiping the reshare enabled post to reveal a list of selectable user actions in accordance with an embodiment;

FIG. 5 shows the screen shot of FIG. 4 depicting the user clicking the reshare icon or button in accordance with an embodiment;

FIG. 6 shows the screen shot of FIG. 5 illustrating a drop down menu of sharing options in accordance with various embodiments;

FIG. 7 shows the screen shot of FIG. 6 in which the user indicates which other social networks where the user desires to publish the post accordance with various embodiments;

FIG. 8 shows the screen shot of FIG. 7 depicting the user confirming the reshare instructions in accordance with various embodiments;

FIG. 9 is a screen shot of a Twitter user interface illustrating the selected post republished on the Twitter platform in accordance with various embodiments;

FIG. 10 is a screen shot of a Facebook user interface illustrating the selected post republished on the Facebook platform in accordance with various embodiments;

FIGS. 11-13 are screen shots of a feed illustrating an alternative method for resharing in accordance with various embodiments; and

FIG. 14 is a flow chart illustrating a method for resharing an enabled post across social network platforms in accordance with various embodiments.

### DETAILED DESCRIPTION

Embodiments of the subject matter described herein generally relate to systems and methods for configuring a post so that it may be shared by other users outside the feed based platform within which the content was originally posted.

On-demand or multi-tenant database system and service environments, such as SALESFORCE.COM™, Twitter™, and Facebook™ allow authors to create posts and present them to one or more fellow users in a scrolling feed. The Chatter™ social network cloud is a web based enterprise file sharing solution that allows users to share information and files with any number of authorized users or groups within their company or organization. Using CHATTER™, users communicate with other users within their organization using mobile devices, desktop computers, tablet computers, and so forth.

In various embodiments, the creator of a post may specifically configure a particular post in a manner which enables other users to reshare the post with other social network platforms and applications including Twitter, Facebook, Google+, StumbleUpon, Pinterest, Dropbox, Google Drive, YouTube, Gmail, and Instagram. In this regard, it should be noted that each company or organization within a multi-tenant environment is typically treated as a private community to protect sensitive data and information that employers may not want their employees to re-share outside the community. One approach is to allow the author of a content post to designate a post (e.g., text, video, photo, poll, file, etc.) as public by appending, embedding, or otherwise associating a predetermined hashtag with the post.

For example, when composing a content post on Chatter the author could use one of the following hashtags to designate the content as public: #social; #reshare; #public; #social-reshare. Alternatively, other hashtags could also be used. Whenever a content post is designated as public in this way, Chatter provides functionality to allow users to re-share the content on other social networks and applications. In the default condition, this resharing functionality will be disabled for content posts not specifically designated by the author as eligible for publication outside the organization.

In one implementation, when content is marked as public, a flag in a Chatter post table is set to indicate the post as re-sharable. When a user attempts to share a post, the system checks the flag to see if it is set. If so, the post may be shared through the Chatter application program interface (API) and/or through other social networking sites' public APIs. Alternatively, if the flag is not set, the option to re-share the post is not displayed to the user.

In an embodiment, the hashtags described above would not automatically reshare the post to another site. Rather, the use of an enabling hashtag would allow any authorized user to repost the enabled post to another social network of their choice provided, however, that the social network has an API which is exposed to the Chatter or other platform from which the post is to be reshared.

The following sequence illustrates one embodiment in which a post may be reshared to another platform: 1) A first user creates a Chatter post; 2) A second Chatter user comments on the post, requesting to reshare the post on another network; 3) The first user adds a comment that contains the appropriate re-share hashtag; 4) Other Chatter users can now click on a button associated with the post to re-share it to another social network of their choosing.

Alternatively, a first Chatter user may create a post which contains a #social hashtag, whereupon any other authorized Chatter user within the first user's organization may re-share the post to another social network platform having a resharing API which is exposed to the Chatter system.

By way of non-limiting illustration, suppose a corporate officer desires to announce the launch of a new product by posting the announcement to the Chatter feed. Since only employees of the company (and authorized partners with access to the feed) can view the post, the creator may designate the post as eligible for resharing outside the Chatter system. Once so enabled, for example by appending a #social/reshare hashtag to the post, other Chatter users are free to repost the announcement to other social networks. In accordance with a preferred embodiment, only the author or creator of a post (or an administrator) has the ability to designate a post as eligible for publication outside the original network.

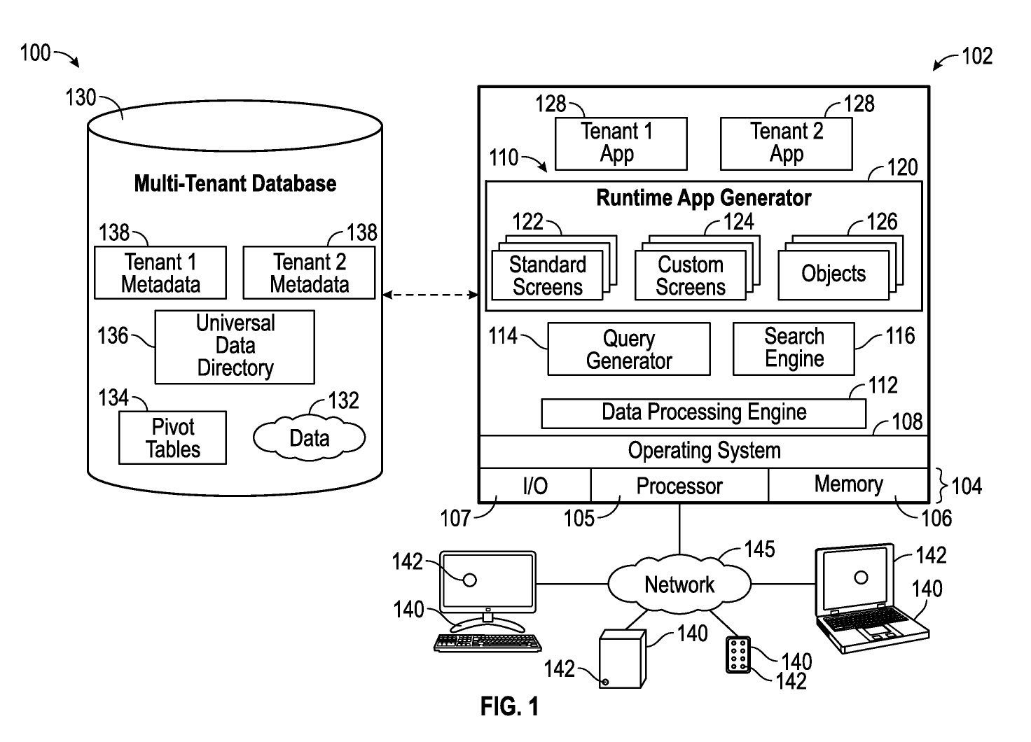

Turning now to FIG. 1, an exemplary cloud based solution may be implemented in the context of a multi-tenant system 100 including a server 102 that supports applications 128 based upon data 132 from a database 130 that may be shared between multiple tenants, organizations, or enterprises, referred to herein as a multi-tenant database. Data and services generated by the various applications 128 are provided via a network 145 to any number of client devices 140, such as desk tops, laptops, tablets, smartphones, Google Glass™, and any other computing device implemented in an automobile, aircraft, television, or other business or consumer electronic device or system, including web clients.

Each application 128 is suitably generated at run-time (or on-demand) using a common application platform 110 that securely provides access to the data 132 in the database 130 for each of the various tenant organizations subscribing to the service cloud 100. In accordance with one non-limiting example, the service cloud 100 is implemented in the form of an on-demand multi-tenant customer relationship management (CRM) system that can support any number of authenticated users for a plurality of tenants.

As used herein, a “tenant” or an “organization” should be understood as referring to a group of one or more users (typically employees) that shares access to common subset of the data within the multi-tenant database 130. In this regard, each tenant includes one or more users and/or groups associated with, authorized by, or otherwise belonging to that respective tenant. Stated another way, each respective user within the multi-tenant system 100 is associated with, assigned to, or otherwise belongs to a particular one of the plurality of enterprises supported by the system 100.

Each enterprise tenant may represent a company, corporate department, business or legal organization, and/or any other entities that maintain data for particular sets of users (such as their respective employees or customers) within the multi-tenant system 100. Although multiple tenants may share access to the server 102 and the database 130, the particular data and services provided from the server 102 to each tenant can be securely isolated from those provided to other tenants. The multi-tenant architecture therefore allows different sets of users to share functionality and hardware resources without necessarily sharing any of the data 132 belonging to or otherwise associated with other organizations.

The multi-tenant database 130 may be a repository or other data storage system capable of storing and managing the data 132 associated with any number of tenant organizations. The database 130 may be implemented using conventional database server hardware. In various embodiments, the database 130 shares processing hardware 104 with the server 102. In other embodiments, the database 130 is implemented using separate physical and/or virtual database server hardware that communicates with the server 102 to perform the various functions described herein.

In an exemplary embodiment, the database 130 includes a database management system or other equivalent software capable of determining an optimal query plan for retrieving and providing a particular subset of the data 132 to an instance of application (or virtual application) 128 in response to a query initiated or otherwise provided by an application 128, as described in greater detail below. The multi-tenant database 130 may alternatively be referred to herein as an on-demand database, in that the database 130 provides (or is available to provide) data at run-time to on-demand virtual applications 128 generated by the application platform 110, as described in greater detail below.

In practice, the data 132 may be organized and formatted in any manner to support the application platform 110. In various embodiments, the data 132 is suitably organized into a relatively small number of large data tables to maintain a semi-amorphous “heap”-type format. The data 132 can then be organized as needed for a particular virtual application 128. In various embodiments, conventional data relationships are established using any number of pivot tables 134 that establish indexing, uniqueness, relationships between entities, and/or other aspects of conventional database organization as desired. Further data manipulation and report formatting is generally performed at run-time using a variety of metadata constructs. Metadata within a universal data directory (UDD) 136, for example, can be used to describe any number of forms, reports, workflows, user access privileges, business logic and other constructs that are common to multiple tenants.

Tenant-specific formatting, functions and other constructs may be maintained as tenant-specific metadata 138 for each tenant, as desired. Rather than forcing the data 132 into an inflexible global structure that is common to all tenants and applications, the database 130 is organized to be relatively amorphous, with the pivot tables 134 and the metadata 138 providing additional structure on an as-needed basis. To that end, the application platform 110 suitably uses the pivot tables 134 and/or the metadata 138 to generate “virtual” components of the virtual applications 128 to logically obtain, process, and present the relatively amorphous data 132 from the database 130.

The server 102 may be implemented using one or more actual and/or virtual computing systems that collectively provide the dynamic application platform 110 for generating the virtual applications 128. For example, the server 102 may be implemented using a cluster of actual and/or virtual servers operating in conjunction with each other, typically in association with conventional network communications, cluster management, load balancing and other features as appropriate. The server 102 operates with any sort of conventional processing hardware 104, such as a processor 105, memory 106, input/output features 107 and the like. The input/output features 107 generally represent the interface(s) to networks (e.g., to the network 145, or any other local area, wide area or other network), mass storage, display devices, data entry devices and/or the like.

The processor 105 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 106 represents any non-transitory short or long term storage or other computer-readable media capable of storing programming instructions for execution on the processor 105, including any sort of random access memory (RAM), read only memory (ROM), flash memory, magnetic or optical mass storage, and/or the like. The computer-executable programming instructions, when read and executed by the server 102 and/or processor 105, cause the server 102 and/or processor 105 to create, generate, or otherwise facilitate the application platform 110 and/or virtual applications 128 and perform one or more additional tasks, operations, functions, and/or processes described herein. It should be noted that the memory 106 represents one suitable implementation of such computer-readable media, and alternatively or additionally, the server 102 could receive and cooperate with external computer-readable media that is realized as a portable or mobile component or platform, e.g., a portable hard drive, a USB flash drive, an optical disc, or the like.

The application platform 110 is any sort of software application or other data processing engine that generates the virtual applications 128 that provide data and/or services to the client devices 140. In a typical embodiment, the application platform 110 gains access to processing resources, communications interfaces and other features of the processing hardware 104 using any sort of conventional or proprietary operating system 108. The virtual applications 128 are typically generated at run-time in response to input received from the client devices 140. For the illustrated embodiment, the application platform 110 includes a bulk data processing engine 112, a query generator 114, a search engine 116 that provides text indexing and other search functionality, and a runtime application generator 120. Each of these features may be implemented as a separate process or other module, and many equivalent embodiments could include different and/or additional features, components or other modules as desired.

The runtime application generator 120 dynamically builds and executes the virtual applications 128 in response to specific requests received from the client devices 140. The virtual applications 128 are typically constructed in accordance with the tenant-specific metadata 138, which describes the particular tables, reports, interfaces and/or other features of the particular application 128. In various embodiments, each virtual application 128 generates dynamic web content that can be served to a browser or other client program 142 associated with its client device 140, as appropriate.

The runtime application generator 120 suitably interacts with the query generator 114 to efficiently obtain multi-tenant data 132 from the database 130 as needed in response to input queries initiated or otherwise provided by users of the client devices 140. In a typical embodiment, the query generator 114 considers the identity of the user requesting a particular function (along with the user's associated tenant), and then builds and executes queries to the database 130 using system-wide metadata 136, tenant specific metadata 138, pivot tables 134, and/or any other available resources. The query generator 114 in this example therefore maintains security of the common database 130 by ensuring that queries are consistent with access privileges granted to the user and/or tenant that initiated the request.

With continued reference to FIG. 1, the data processing engine 112 performs bulk processing operations on the data 132 such as uploads or downloads, updates, online transaction processing, and/or the like. In many embodiments, less urgent bulk processing of the data 132 can be scheduled to occur as processing resources become available, thereby giving priority to more urgent data processing by the query generator 114, the search engine 116, the virtual applications 128, etc.

In exemplary embodiments, the application platform 110 is utilized to create and/or generate data-driven virtual applications 128 for the tenants that they support. Such virtual applications 128 may make use of interface features such as custom (or tenant-specific) screens 124, standard (or universal) screens 122 or the like. Any number of custom and/or standard objects 126 may also be available for integration into tenant-developed virtual applications 128. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system.

The data 132 associated with each virtual application 128 is provided to the database 130, as appropriate, and stored until it is requested or is otherwise needed, along with the metadata 138 that describes the particular features (e.g., reports, tables, functions, objects, fields, formulas, code, etc.) of that particular virtual application 128. For example, a virtual application 128 may include a number of objects 126 accessible to a tenant, wherein for each object 126 accessible to the tenant, information pertaining to its object type along with values for various fields associated with that respective object type are maintained as metadata 138 in the database 130. In this regard, the object type defines the structure (e.g., the formatting, functions and other constructs) of each respective object 126 and the various fields associated therewith.

Still referring to FIG. 1, the data and services provided by the server 102 can be retrieved using any sort of personal computer, mobile telephone, tablet or other network-enabled client device 140 on the network 145. In an exemplary embodiment, the client device 140 includes a display device, such as a monitor, screen, or another conventional electronic display capable of graphically presenting data and/or information retrieved from the multi-tenant database 130, as described in greater detail below.

Typically, the user operates a conventional browser application or other client program 142 executed by the client device 140 to contact the server 102 via the network 145 using a networking protocol, such as the hypertext transport protocol (HTTP) or the like. The user typically authenticates his or her identity to the server 102 to obtain a session identifier (“SessionID”) that identifies the user in subsequent communications with the server 102. When the identified user requests access to a virtual application 128, the runtime application generator 120 suitably creates the application at run time based upon the metadata 138, as appropriate. However, if a user chooses to manually upload an updated file (through either the web based user interface or through an API), it will also be shared automatically with all of the users/devices that are designated for sharing.

As noted above, the virtual application 128 may contain Java, ActiveX, or other content that can be presented using conventional client software running on the client device 140; other embodiments may simply provide dynamic web or other content that can be presented and viewed by the user, as desired. As described in greater detail below, the query generator 114 suitably obtains the requested subsets of data 132 from the database 130 as needed to populate the tables, reports or other features of the particular virtual application 128. In various embodiments, application 128 embodies the functionality of a resharing protocol, described below.

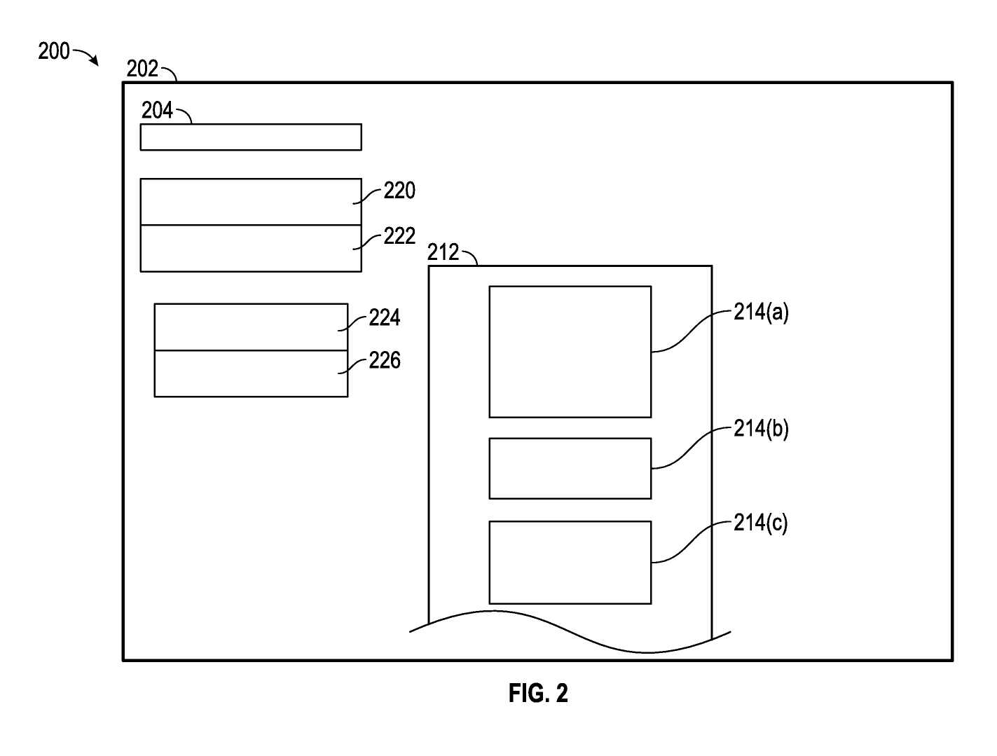

Referring now to FIG. 2, an exemplary layout 200 for a feed-based user interface of the type used in a multi-tenant based social network includes a screen 202 within a browser window. The screen 202 may include one or more branding indicia 204 such as the company name, logo, the Chatter name, and the like, a login button 220, and a “sign up” or “register” function 222. Group, company, organization, or team affiliation indicia 224 and user indicia 226 (which may include a user photo or avatar) may also be displayed. Various posts, news items, or any combination of desired content may be displayed in a real time, continuously updatable feed 212 configured to sequentially display posts 214(a), 214 (b) . . . 214 (n). As described in greater detail below, a properly enabled post may be reshared outside the network platform shown in FIG. 2.

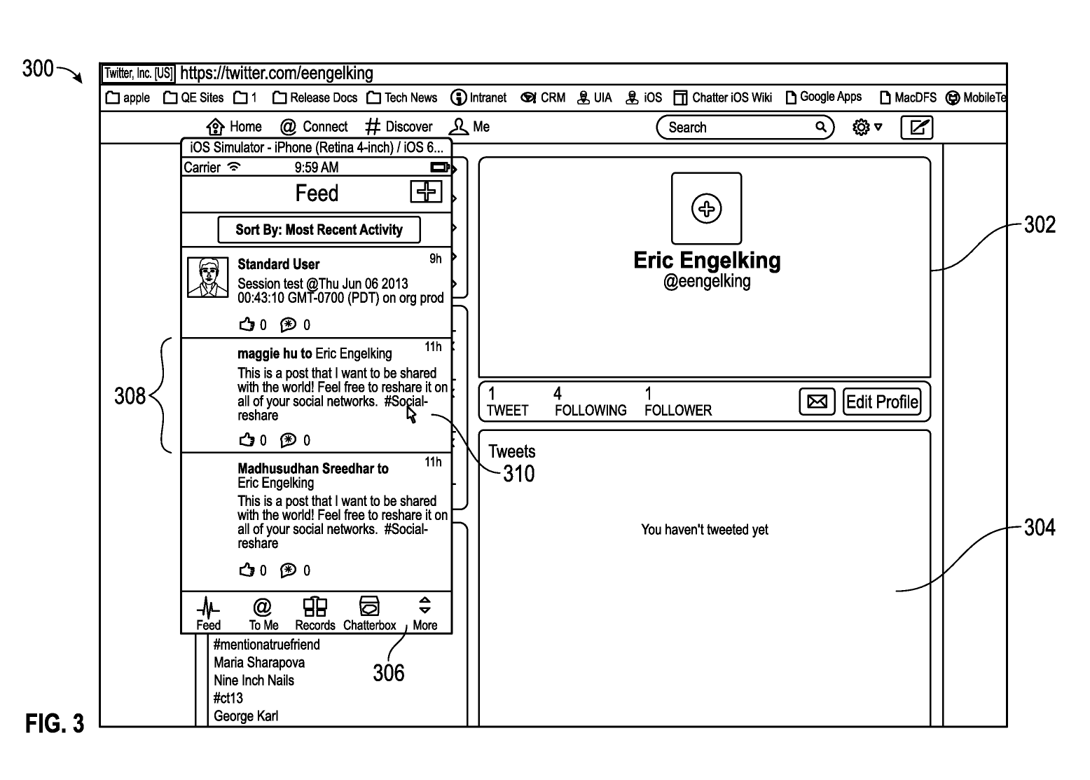

FIG. 3 is a screen shot 300 of an exemplary Chatter feed 306 overlaying a Twitter page including a user name field 302 and a Twitter feed 304. The Chatter feed 306 includes at least one post 308 which is enabled for resharing by including a reshare hashtag 310.

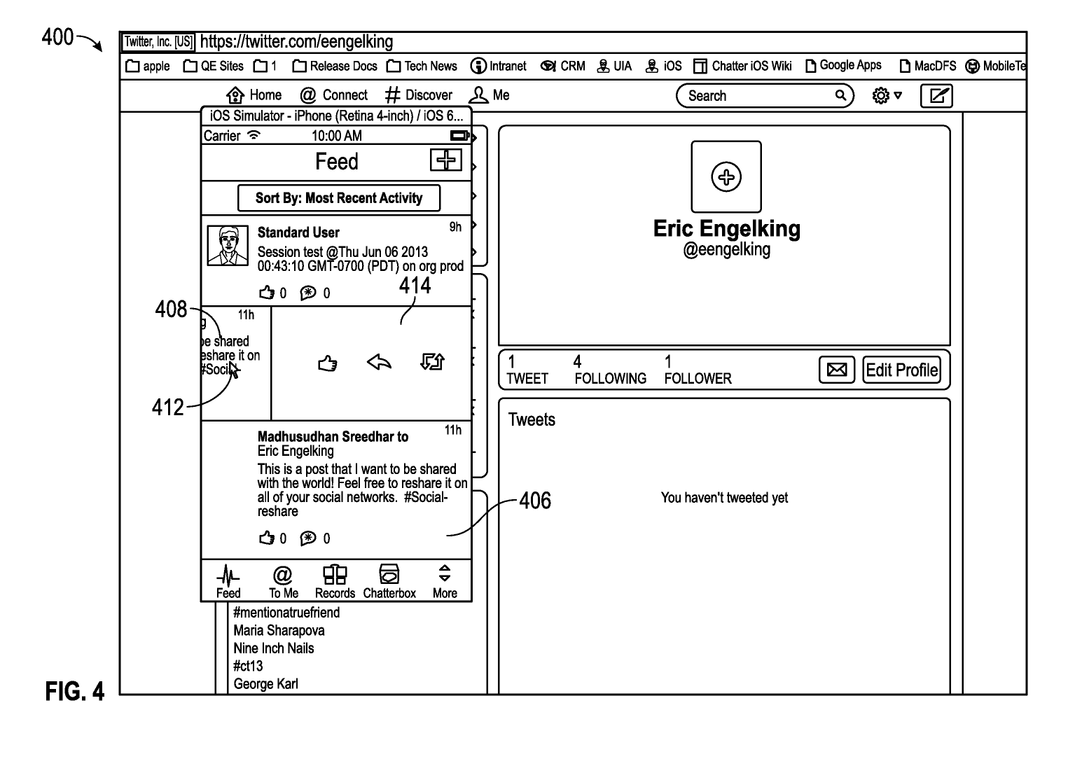

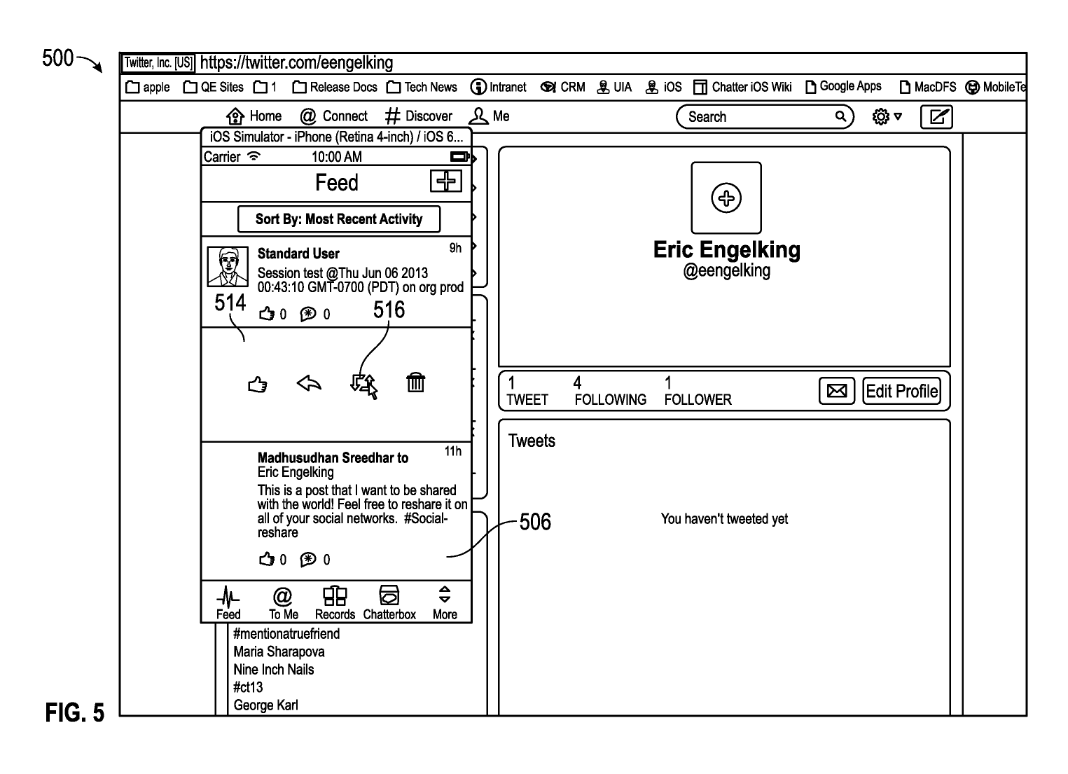

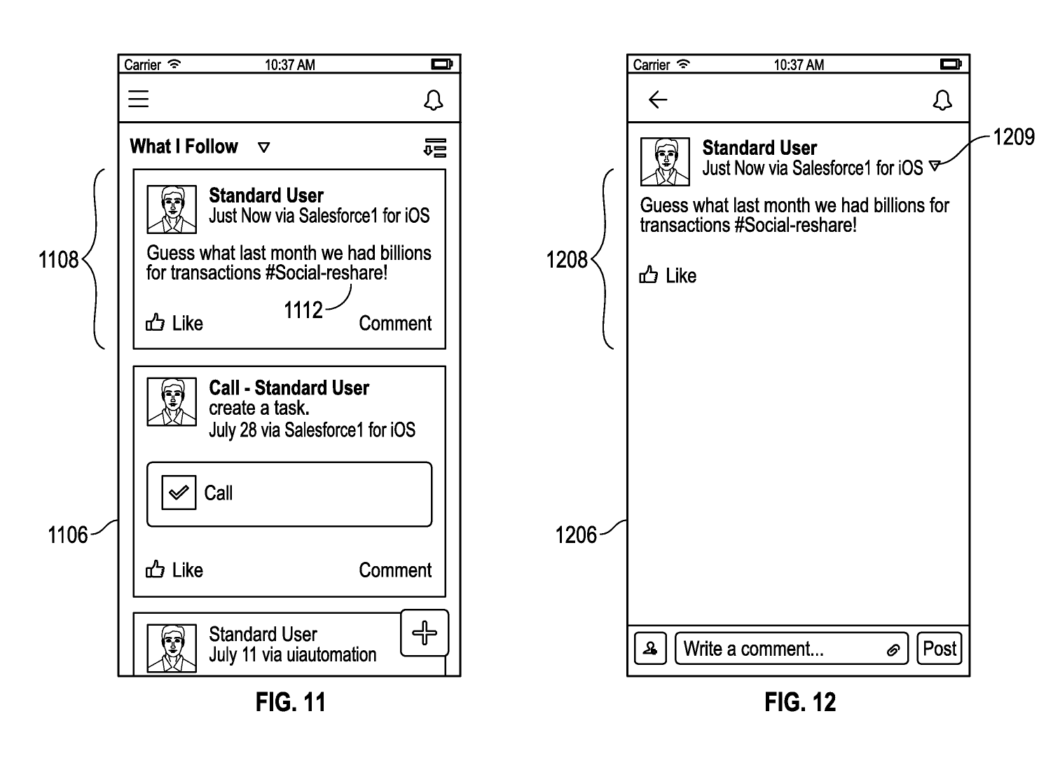

FIG. 4 is a screen shot 400 depicting the user swiping the reshare enabled post 408 using a cursor 412 within a Chatter feed 406 to reveal a list 414 of selectable user actions. FIG. 5 is a screen shot 500 showing the user clicking a reshare icon or button 516 from a list 516 within a Chatter feed 506. An alternate technique for resharing is described below in connection with FIGS. 11-13.

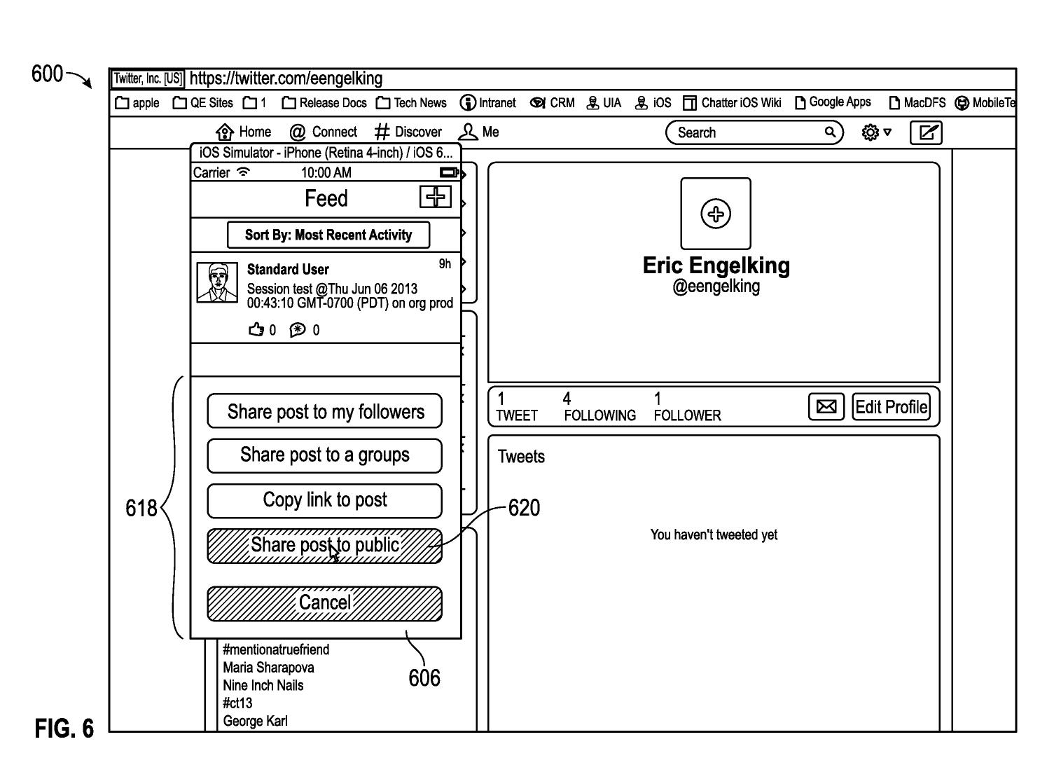

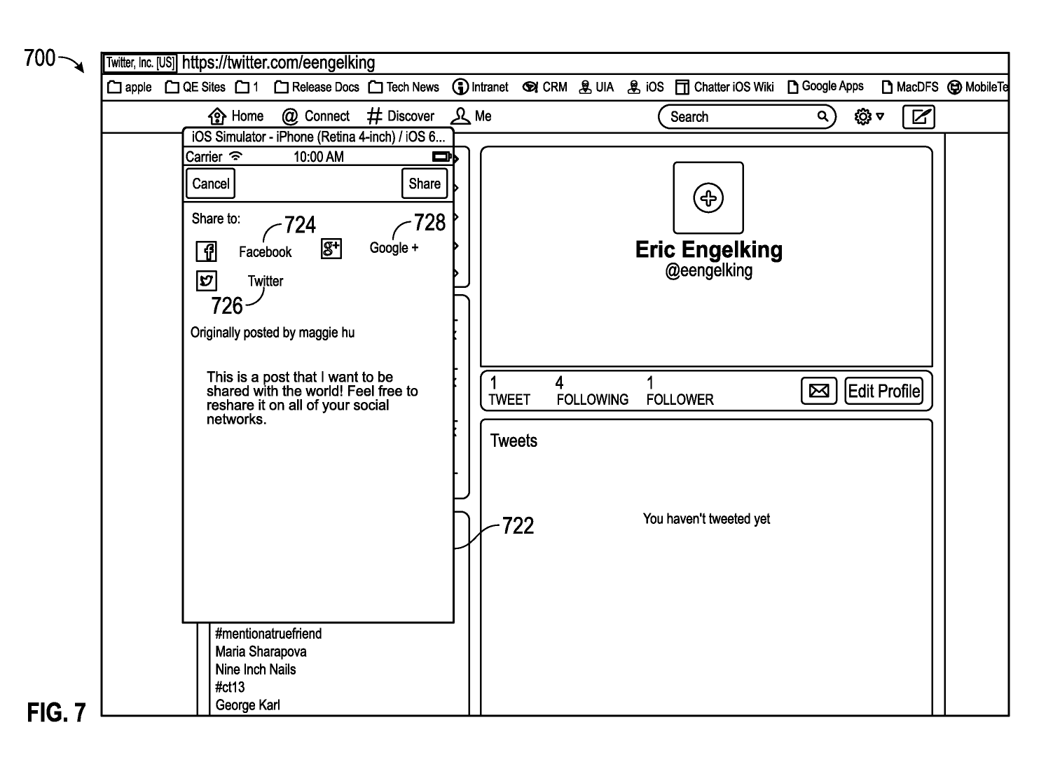

FIG. 6 is a screen shot 600 illustrating a drop down menu 618 of sharing options including a “share post to public” option 620. As described below in conjunction with FIG. 7, by clicking on or otherwise selecting the public post option 620, the system displays those other social network platforms which expose a reshare API with the Chatter system.

Referring now to FIG. 7, a screen shot 700 illustrates a sharing box 722 which presents the user with various external social network platforms to which the previously selected post may be published. In the illustrated example, the sharing box includes a first network (e.g., Facebook) 724, a second network (e.g., Twitter) 726, and a third network (e.g., Google+) 728. The user may select any one or more (or none) of these networks for resharing the previously selected post. In the illustrated example, the user selects the second network 726 (Twitter).

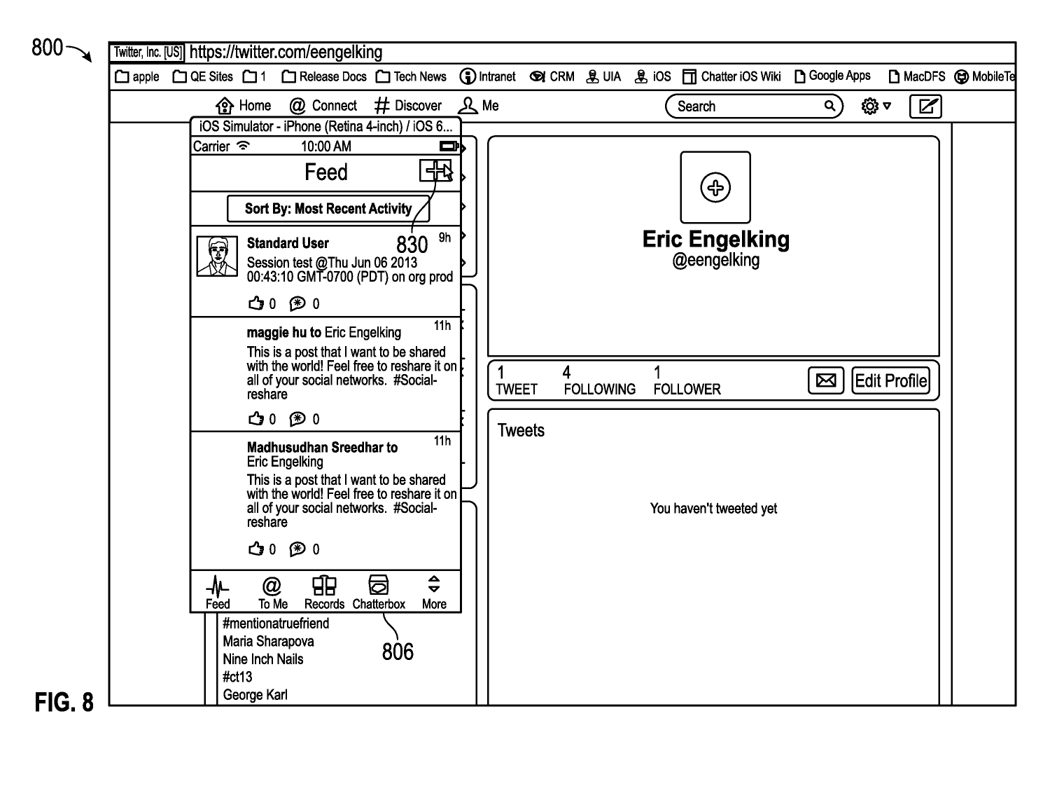

FIG. 8 is a screen shot 800 depicting the user confirming the reshare instructions by clicking a confirmation icon 830 within a Chatter feed 806.

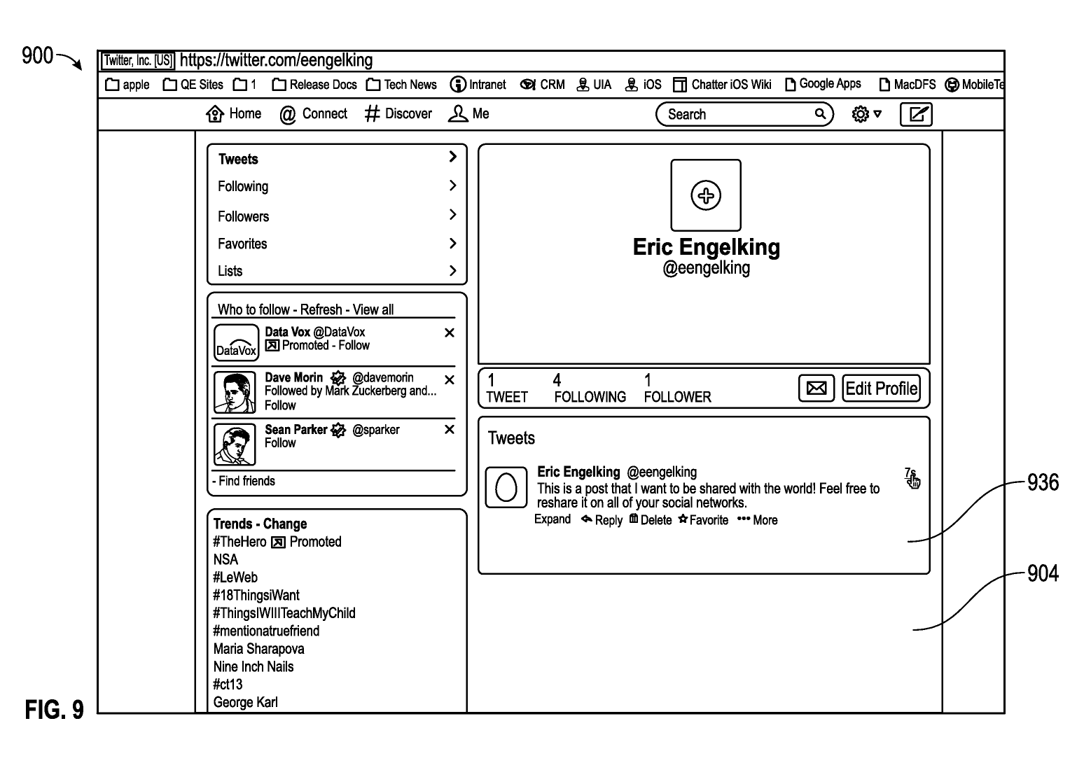

FIG. 9 is a screen shot 900 of a Twitter user interface having a Twitter feed 904 displaying the selected post 936 as it appears republished on the Twitter platform.

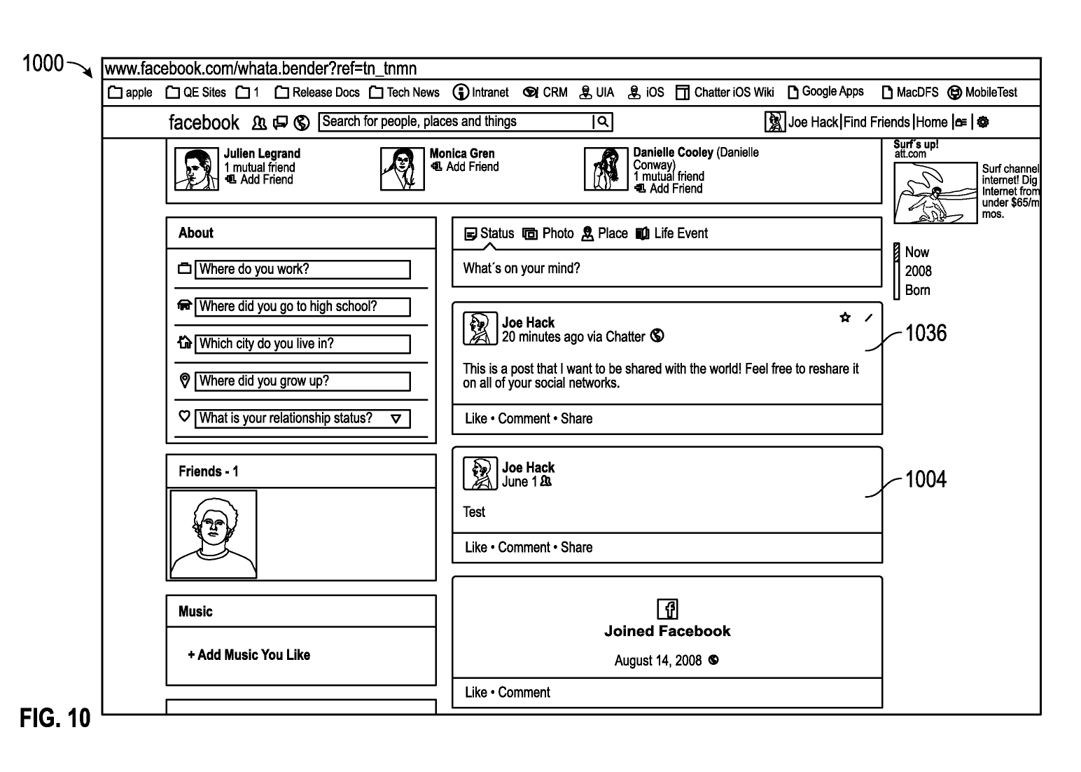

FIG. 10 is a screen shot 1000 of a Facebook user interface having a Facebook feed 1004 displaying the selected post 1036 as it appears republished on the Facebook platform.

FIGS. 11-13 depict an alternative method for resharing a post enabled for publication outside of a first social network (e.g., Chatter). More particularly, FIG. 11 shows a Chatter feed 1106 including a post 1108 which is designated for re-publication (or resharing) outside of the Chatter platform, as evidenced by the presence of the #social-reshare hashtag 1112. Clicking on the post 1108 reveals relevant post detail.

Referring now to FIG. 12, a Chatter feed 1206 displays a post 1208 including additional detail, such as, for example, a down arrow 1209. By clicking on the down arrow 1209, various actions and/or functions may be displayed. For example and with reference to FIG. 13, a Chatter feed 1306 displays an options menu 1309 including a “Share Post to Public) button 1311. By selecting (e.g., clicking on) the reshare button 1311, the system may then display a list of networks, platforms, sites, or the like in which the selected post may be displayed, as generally discussed above in conjunction with FIG. 7.

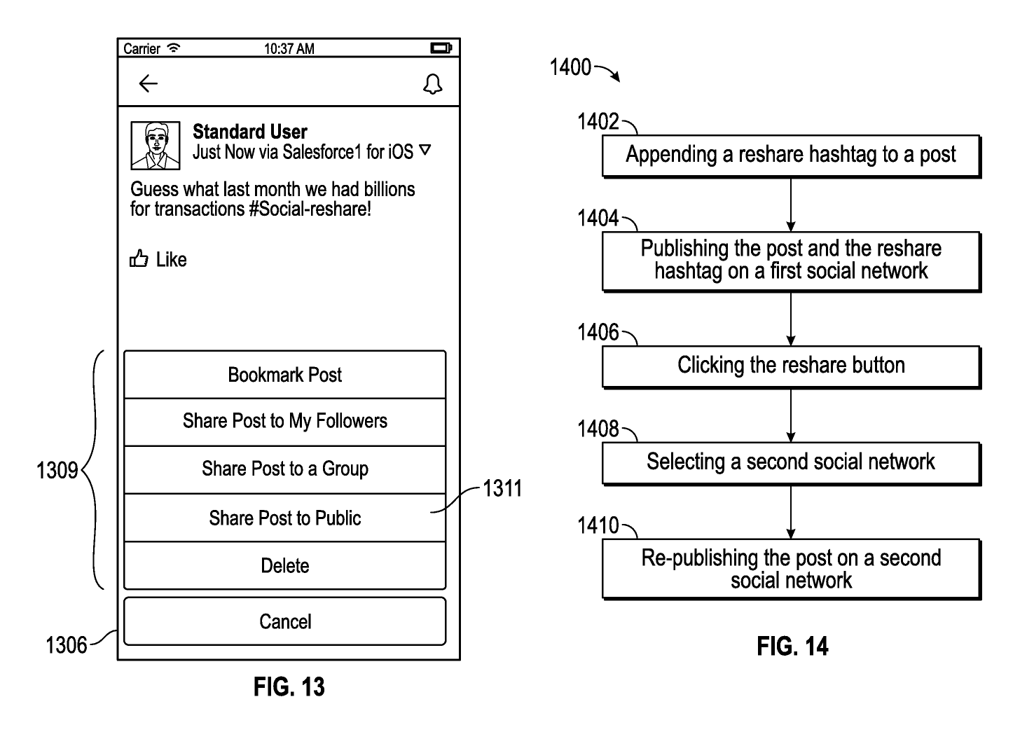

FIG. 14 is a flow chart illustrating a method 1400 for resharing an enabled post across social network platforms. More particularly, the method 1400 includes appending (Task 1402) a reshare hashtag to a post, and publishing (Task 1404) the post and the reshare hashtag on a first social network. The method 1400 further involves clicking (1406) or otherwise activating a reshare button, icon, or the like associated with the post, and selecting (Task 1408) a second social network. The post may then be republished (Task 1410) on the second social network.

A method is thus provided for resharing a feed post in an on-demand multi-tenant social network. The method may include: appending, by a first member of an organization, a reshare hashtag to a post configured for publication on a first social network; publishing, by the first member, the post including the appended reshare hashtag to at least a second member of the organization on the first social network; clicking, by a second member, a resharing button; selecting, by the second member, a second social network; and re-publishing the post on the second social network.

In an embodiment, the reshare hashtag comprises the # symbol and a predetermined word recognized by the first social network as enabling publication of the post outside of the first social network.

In an embodiment, the reshare hashtag comprises one of the following terms: #social; #reshare; #public; and #social-reshare.

In an embodiment, the method further includes displaying, in response to clicking the reshare button, a list including at least the second social network.

In an embodiment, re-publishing comprises displaying the post in a feed associated with the second social network.

In an embodiment, the organization comprises a closed user community.

In an embodiment, the first social network is configured to detect a resharing application program interface (API) associated with the second social network.

A method is also provided for re-publishing a post outside of a first social network. The method may include: publishing, by a first user, a post to a second user on a first social network; requesting, by the second user, permission to re-publish the post outside the first social network; designating, by the first user, the post as public; and re-publishing, by the second user, the post on a second social network.

In an embodiment, designating comprises appending a public hashtag to the post.

In an embodiment, the method may also include: clicking, by the second member, the public (resharing) button; and selecting, by the second member, a second social network.

In an embodiment, the public hashtag comprises the # symbol and a predetermined word recognized by the first social network as enabling publication of the post outside of the first social network.

In an embodiment, the method may also include displaying for the second user, in response to clicking the public button, a list including at least the second social network.

In an embodiment, re-publishing comprises displaying the post in a feed associated with the second social network.

In an embodiment, the first social network is configured to detect a resharing application program interface (API) associated with the second social network.

A computer application embodied in a non-transitory medium is also provided for operation by a computer processor associated with a first on-demand social network feed. The application may be configured to implement the steps of: appending, by a first member of an organization, a reshare hashtag to a post configured for publication on a first social network; publishing, by the first member, the post including the appended reshare hashtag to at least a second member of the organization on the first social network; clicking, by a second member, reshare button; selecting, by the second member, a second social network; and re-publishing the post on the second social network.

In an embodiment, the reshare hashtag comprises the # symbol and a predetermined word recognized by the first social network as enabling publication of the post outside of the first social network.

In an embodiment, the computer application may be further configured to display, in response to clicking the reshare button, a list including at least the second social network.

In various embodiments, the second social network comprises one of Twitter, Facebook, Linkedin, Pinterest, Tumblr, Google+, Hootsuite, Yammer, Path, Instagram, Weibo, QZone, and Vine platforms.

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” means “serving as an example, instance, or illustration.” Any implementation described herein as exemplary is not necessarily to be construed as preferred or advantageous over other implementations, and the exemplary embodiments described herein are not intended to limit the scope or applicability of the subject matter in any way.

For the sake of brevity, conventional techniques related to computer programming, computer networking, database querying, database statistics, query plan generation, XML and other functional aspects of the systems (and the individual operating components of the systems) may not be described in detail herein. In addition, those skilled in the art will appreciate that embodiments may be practiced in conjunction with any number of system and/or network architectures, data transmission protocols, and device configurations, and that the system described herein is merely one suitable example. Furthermore, certain terminology may be used herein for the purpose of reference only, and thus is not intended to be limiting. For example, the terms “first”, “second” and other such numerical terms do not imply a sequence or order unless clearly indicated by the context.

Embodiments of the subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In this regard, it should be appreciated that the various block components shown in the figures may be realized by any number of hardware, software, and/or firmware components configured to perform the specified functions.

For example, an embodiment of a system or a component may employ various integrated circuit components, e.g., memory elements, digital signal processing elements, logic elements, look-up tables, or the like, which may carry out a variety of functions under the control of one or more microprocessors or other control devices. In this regard, the subject matter described herein can be implemented in the context of any computer-implemented system and/or in connection with two or more separate and distinct computer-implemented systems that cooperate and communicate with one another. That said, in exemplary embodiments, the subject matter described herein is implemented in conjunction with a virtual customer relationship management (CRM) application in a multi-tenant environment.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application. Accordingly, details of the exemplary embodiments or other limitations described above should not be read into the claims absent a clear intention to the contrary.

What is claimed:

1. A method of resharing a feed post in an on-demand multi-tenant social network the method comprising:
appending, by a first member of an organization, a reshare hashtag to a post configured for publication on a first social network;
publishing, by the first member, the post including the appended reshare hashtag to at least a second member of the organization on the first social network;
clicking, by a second member, a resharing button;
selecting, by the second member, a second social network; and
re-publishing the post on the second social network.

2. The method of claim 1, wherein the reshare hashtag comprises the # symbol and a predetermined word recognized by the first social network as enabling publication of the post outside of the first social network.

3. The method of claim 1, wherein the reshare hashtag comprises one of the following terms: #social; #reshare; #public; and #social-reshare.

4. The method of claim 1, further comprising displaying, in response to clicking the reshare button, a list including at least the second social network.

5. The method of claim 1, wherein re-publishing comprises displaying the post in a feed associated with the second social network.

6. The method of claim 1, wherein the organization comprises a closed user community.

7. The method of claim 1, wherein the first social network is configured to detect a resharing application program interface (API) associated with the second social network.

8. A method of re-publishing a post outside of a first social network, comprising:
publishing, by a first user, a post to a second user on a first social network;
requesting, by the second user, permission to re-publish the post outside the first social network;
designating, by the first user, the post as public; and
re-publishing, by the second user, the post on a second social network.

9. The method of claim 8, wherein designating comprises appending a public hashtag to the post.

10. The method of claim 9, further comprising:
clicking, by the second member, resharing button; and
selecting, by the second member, a second social network.

11. The method of claim 10, wherein the public hashtag comprises the # symbol and a predetermined word recognized by the first social network as enabling publication of the post outside of the first social network.

12. The method of claim 10, further comprising displaying for the second user, in response to clicking the resharing button, a list including at least the second social network.

13. The method of claim 10, wherein re-publishing comprises displaying the post in a feed associated with the second social network.

14. The method of claim 10 wherein the first social network is configured to detect a resharing application program interface (API) associated with the second social network.

15. A computer application embodied in a non-transitory medium for operation by a computer processor associated with a first on-demand social network feed, the application configured to implement the steps of:
appending, by a first member of an organization, a reshare hashtag to a post configured for publication on a first social network;
publishing, by the first member, the post including the appended reshare hashtag to at least a second member of the organization on the first social network;
clicking, by a second member, a reshare button;
selecting, by the second member, a second social network; and
re-publishing the post on the second social network.

16. The computer application of claim 15 wherein the reshare hashtag comprises the # symbol and a predetermined word recognized by the first social network as enabling publication of the post outside of the first social network.

17. The computer application of claim 15, further configured to display, in response to clicking the reshare button, a list including at least the second social network.

18. The computer application of claim 15, wherein the organization comprises a closed user community.

19. The computer application of claim 15, wherein the first social network is configured to detect a resharing application program interface (API) associated with the second social network.

20. The computer application of claim 15, wherein the second social network comprises one of Twitter, Facebook, Linkedin, Pinterest, Tumblr, Google+, Hootsuite, Yammer, Path, Instagram, Weibo, QZone, and Vine platforms.
